(19) United States
(12) Patent Application Publication
(10) Pub. No.: US 2006/0203122 A1
(43) Pub. Date: Sep. 14, 2006

(54) Imaging apparatus

(75) Inventors: Haruto Tokuyama, Chiba (JP); Masakazu Koyanagi, Chiba (JP); Akira Shiga, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/355,411

(22) Filed: Feb. 16, 2006

(30) Foreign Application Priority Data
Feb. 18, 2005 (JP) P2005-042913

(51) Int. Cl. H04N 5/222

(52) U.S. Cl. 348/370

(57) ABSTRACT

An imaging apparatus can photograph without making a user feel a wasteful photographing impossible time and stress. The imaging apparatus has a light emission unit; an anticipated temperature calculator that calculates an anticipated temperature of the light emission unit based on a light emission state; and a controller for suppressing a charging current or a light emission energy of the light emission unit based on the anticipated temperature.

### CROSS-REFERENCE TO RELATED APPLICATIONS

The present application claims priority from Japanese Patent Application No. JP 2005-042913 filed on Feb. 18, 2005, the disclosure of which is hereby incorporated by reference herein.

### BACKGROUND OF THE INVENTION

The present invention relates to an imaging apparatus having a light emitting unit. More particularly, the invention relates to an imaging apparatus having a function of preventing the temperature rise in the light emitting unit.

In related art, for example, proposed is a strobo unit which has a temperature detector near a strobo light emitting unit to detect a temperature rise and delay a light emitting interval so as to prevent the temperature rise in the strobo light emitting unit. In this strobo unit, a user recognizes as if photographing is impossible in an uncharged state by making a delay mode also serving as a display of strobo uncharged state. Then, the user can use a camera without feeling strangeness (for example, refer to Patent Document 1: Jpn. Pat. Appln. Laid-Open Publication No. Hei 10-206941).

Further, in the strobo unit, a temperature rise is prevented by controlling a charging current from a charging voltage and the count of the number of times of light emissions, absorbing a difference of the light emitting interval by a power supply, or by controlling the time of inhibiting a release by detecting an external power supply, and counting a temperature sensor and the number of times of light emissions (for example, refer to Patent Document 2: Jpn. Pat. Appln. Laid-Open PublicationNo. Hei 10-186470, and Patent Document 3: Jpn. Pat. Appln. Laid-Open Publication No. 2003-304419).

In related art, a camera uses an auxiliary light of a strobo, automatic focusing (AF) with low illuminance, a strobo light emitting unit for preventing bloodshot eyes, or a light emitting diode, irrespective of an internal or external mounting. Each of these auxiliary lights has a relatively high output to transmit a light far away. Therefore, a temperature rise at the time of continuous driving is a problem. Furthermore, recently, a heat dissipation space is particularly limited due to a miniaturization of a camera itself. It becomes difficult to introduce a mechanical countermeasure to a camera.

However, like the disclosed technology of Patent Document 1, the use of a temperature sensor to detect the temperature rise affects not only the cost, but also largely affects the size, mounting and manufacture of a unit because there is a necessity of gaining a creepage for insulation due to a very high voltage of the strobo block as compared with other block.

Moreover, like the disclosed technology of Patent Document 2, a charging current is controlled from the counting of the charging voltage and the number of times of light emissions so as to absorb a difference of light emission interval by a power supply. However, the counting of the number of times of the light emission causes a uniform counting up even in the light emission of long interval and weak light emission. Accordingly, there is possibility of lengthen a light emission interval, even if a temperature does not actually rise when a unit is used for a long period of time.

Further, when a light emission interval is controlled in the case of inhibiting time of charging, there is concern that a photographing impossible time is further lengthened from a user's point of view because the charging times are actually different according to the state of the power supply of the unit. Furthermore, when a heating state is judged according to a light emission frequency, an error of an anticipated temperature is concerned because the energy of the light emission pulse is different according to each light emission.

When an inhibiting time is increased or decreased by a predetermined value, there is concern that the wasteful light emission inhibiting time may be occurred from a user's point of view because an actual temperature rise is not constant and, in a heat dissipation, a temperature falls faster at a higher temperature.

Accordingly, it is desirable to provide an imaging apparatus which can photograph without making a user feeling a wasteful photographing impossible time and stress, in view of the above-mentioned conventional problem.

Another object of the present invention and concrete advantages of the present invention will further be clarified from the description of embodiments described below.

### SUMMARY OF THE INVENTION

The present invention provides an imaging apparatus including a light emission unit; an anticipated temperature calculator which calculates an anticipated temperature of the light emission unit based on a light emission state; and a controller for suppressing a charging current or a light emission energy of the light emission unit based on the anticipated temperature.

According to the present invention, the characteristics of hardware are described by adopting parameters of the relatively less number of times than a prior art so as to prevent the excessive temperature rise. Thus, a difference of hardware can be absorbed. Furthermore, a temperature detection mechanism is not provided in the light emission unit. Accordingly, the number of parts can be reduced. Moreover, the operation is determined based on the anticipated value of the actual temperature. Accordingly, even if the light emission is performed with the low voltage of a power supply, it is not shifted to a suppression mode when it is not necessary to limit the light emission, such as when the amount of light emission is small and the temperature rise is low. Therefore, the user can photograph without feeling a wasteful photographing impossible time and stress.

### BRIEF DESCRIPTION OF THE DRAWINGS

FIG. 1 is a block diagram showing a configuration of an imaging apparatus to which the present invention is applied;

FIG. 2 is a block diagram showing a configuration of a strobo light emission unit in the imaging apparatus;

FIG. 3 is a characteristic diagram showing an anticipated heat dissipation curve by an IIR simulation in the imaging apparatus;

FIG. 4 is a characteristic diagram showing an anticipated temperature rise curve (A1, B1, C1, D1, E1 and F1) according to the IIR simulation of each light emission amount and an actually measured temperature rise curve (A2, B2, C2, D2, E2 and F2);

FIG. 5 is a flowchart showing an operation of an anticipated temperature calculator which calculates the anticipated temperature of the strobo light emission unit based on a light emission state and a system controller which functions as a controller for suppressing the charging current or the light emission energy of the strobo light emission unit based on the anticipated temperature calculated by the anticipated temperature calculator in the imaging apparatus; and

FIG. 6 is a characteristic diagram showing the anticipated temperature rise curve (a) by the IIR simulation of ΔT, the actually measured temperature rise curve (b) and an error curve (c).

### DETAILED DESCRIPTION

Hereinafter, embodiments of the present invention will be described in detail by referring to the drawings. Incidentally, the present invention is not limited to the following embodiments. However, the present invention may be arbitrarily changed within the scope of the invention without departing from the subject matter of the invention.

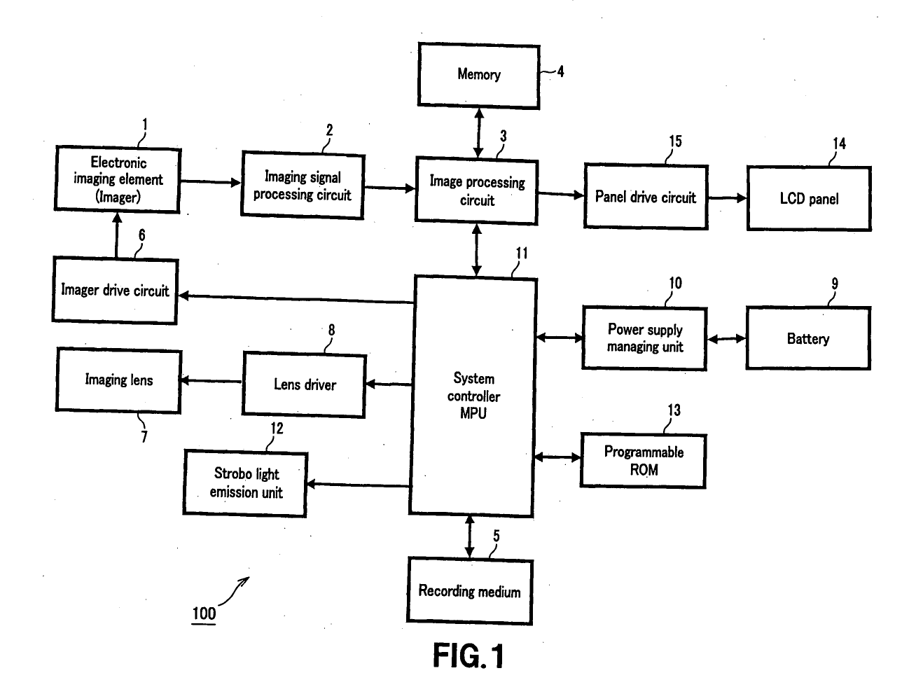

The present invention is applied to an imaging apparatus 100 of the configuration as shown in FIG. 1, for example.

The imaging apparatus 100 comprises a system controller 11 for controlling to write imaging data obtained from an electronic imaging element 1, such as a CCD imager, a CMOS imager, etc., through an imaging signal processing circuit 2 and an image processing circuit 3 in a memory 4 and to record the imaging data in a recording medium 5.

To the system controller 11, an imager drive circuit 6 for driving the electronic imaging element 1, a lens driver 8 for moving an imaging lens 7 for focusing a subject image on the imaging surface of the electronic imaging element 1 in an optical axis direction, a power supply managing unit 10 connected to a battery 9, a strobo light emission unit 12, a programmable ROM 13, etc., are connected.

Further, to the image processing circuit 3, a panel drive circuit 15 for driving an LCD panel 14 for an image monitor is connected.

The system controller 11 is made of, for example, a microprocessor. The system controller 11 performs an automatic focus (AF) control for moving the photographing lens 7 by the lens driver 8 in an optical axis direction based on imaging data obtained through the image processing circuit 3, an automatic exposure (AE) control for optimizing the amount of exposure of the electronic imaging element 1. The system controller 11 controls the light emission of the strobo light emission unit 12 in cooperation with the operation of a release button (not shown).

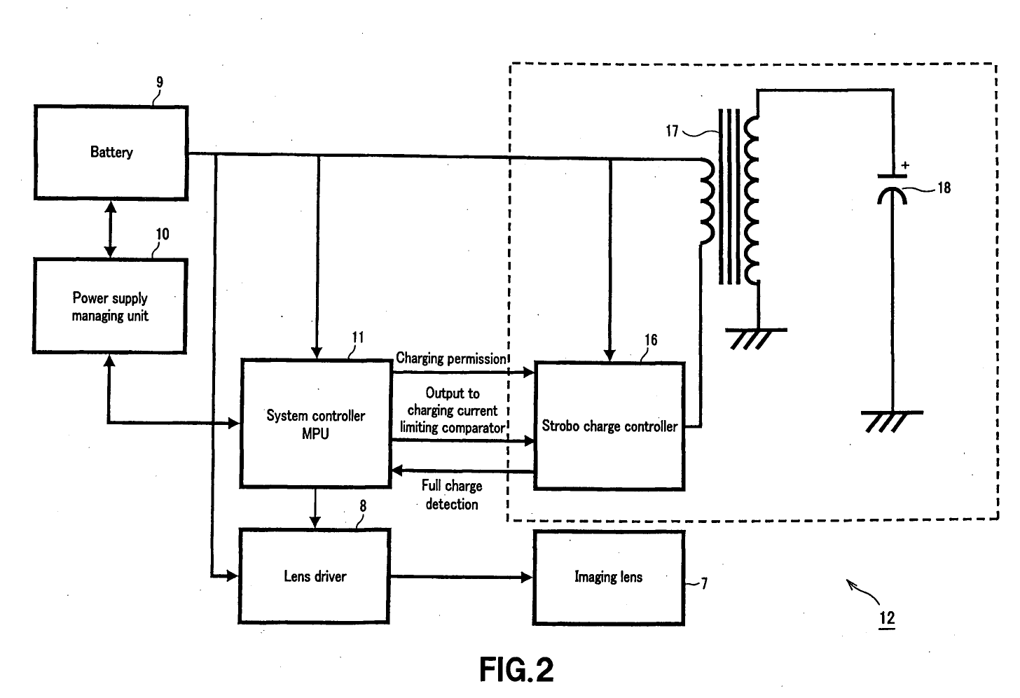

Furthermore, the strobo light emission unit 12 has, as shown in FIG. 2, a strobo charge controller 16 which is controlled by the system controller 11, and a capacitor 18 charged through a step-up transformer 17 connected to the battery 9. A strobo lamp (now shown) performs light emission by charge stored in this capacitor 18.

Here, characteristic of the present invention in this imaging apparatus 100 is to control the temperature rise by calculating the anticipated temperature of the portion desired to be prevented from the temperature rise without detecting temperature of a strobo and light emission diode.

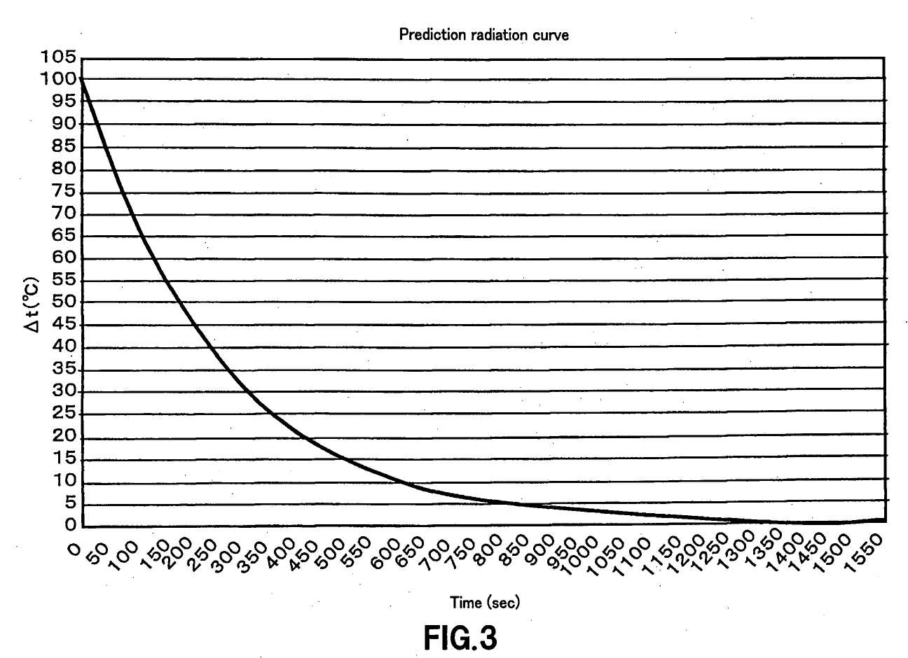

That is, a differential item (proportional to a temperature difference Δt) of the portion desired to be prevented from the temperature rise can be obtained from the heat dissipation curve measured at designing time. Accordingly, as FIG. 3 shows that the anticipated heat dissipation curve by the IIR simulation, the heat dissipation curve can be approximated by a geometric series when sampled at a predetermined time, as shown by an anticipated heat dissipation curve by the IIR simulation in FIG. 3.
Δtn=α*ΔTn−1 formula 1

Here, 0<α<1 is satisfied.

Here, α is obtained by actually measuring the heat dissipation curve of the system and approximating it by formula 1.

Subsequently, in the case of the light emission unit which continuously emits energy, such as Gn of the amount of light emission, a light emission interval, a light emission diode, etc., in the strobo, the light emission interval is set constant. Then, the temperature Th which saturates the temperature rise curve is obtained.

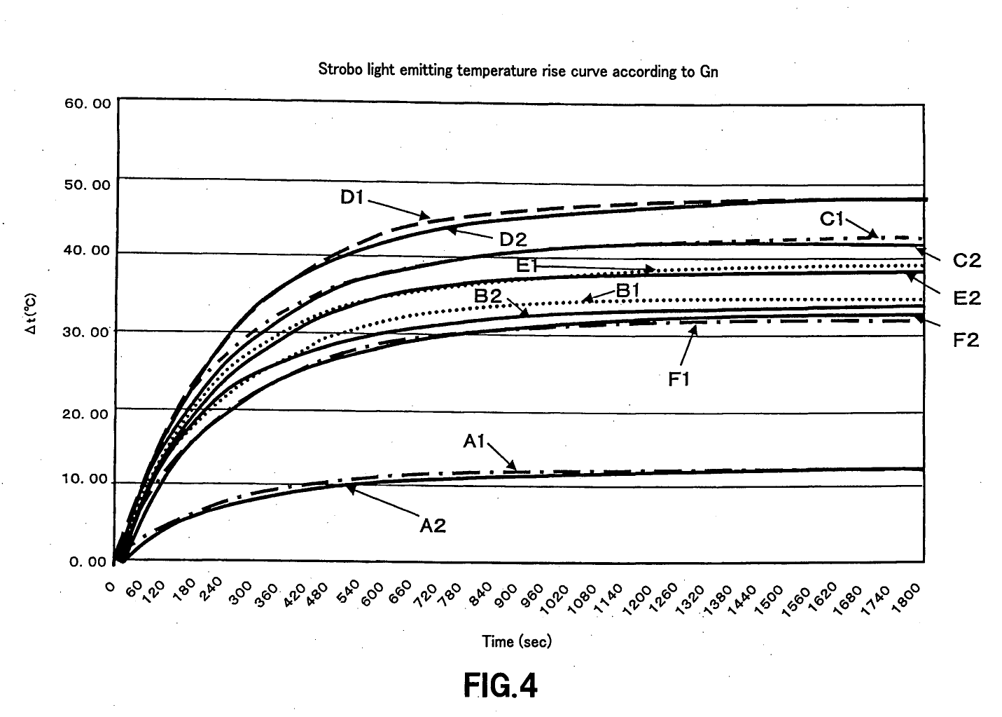

Here, in eight examples of the case (A) that the light emission is performed for 100 μsec at an interval of 8 sec, the case (B) that the light emission is performed for 500 μsec at an interval of 8 sec, the case (C) that the light emission is performed for 1000 μsec at an interval of 8 sec, the case (D) that the light emission is performed for 2000 μsec at an interval of 8 sec, the case (E) that the light emission is performed for 2000 μsec at an interval of 10 sec, the case (F) that the light emission is performed for 2000 μsec at an interval of 12 sec, anticipated temperature rise curves (A1, B1, C1, D1, E1 and F1) by the IIR simulation according to the amount of light emission Gn and the actually measured temperature rise curves (A2, B2, C2, D2, E1 and F2) are shown in FIG. 4.

The thermal energy emitted per hour under the condition is calculated from the above results and the heat dissipation curve. In this case, a proportional relation exists between the Duty ratio and the heat radiation energy En to the light emission interval (En=β*Duty*Time, where Time is a sampling period). Then, the Gn and the heat radiation energy En can be approximated by the relation of a quadric function (En=β*Gn2+γ).

As described above, the balance between the energy emitted per hour as described above and the heat dissipation energy Th*(1−α)=En is used. Then, the parameter (here β and γ) for calculating the energy emitted per hour is obtained. Thus, the calculation formula of the temperature rise energy can be prepared from the amount of light emission Gn and the light emission of the LED.

Incidentally, the transformation from the amount of light emission Gn to the heat radiation energy En may be performed by a linear interpolation or a table transformation.

After the design of the system or at the production time, these parameters are measured at the line regulation time, and are previously stored as information intrinsic for the device in the programmable ROM 13.

In this imaging apparatus 100, the system controller 11 functions as an anticipated temperature calculator for calculating the anticipated temperature of the strobo light emission unit 12 based on the light emission state, and a controller for suppressing the charging current or the light emission energy of the strobo light emission unit 12 based on the anticipated temperature calculated by the anticipated temperature calculator.

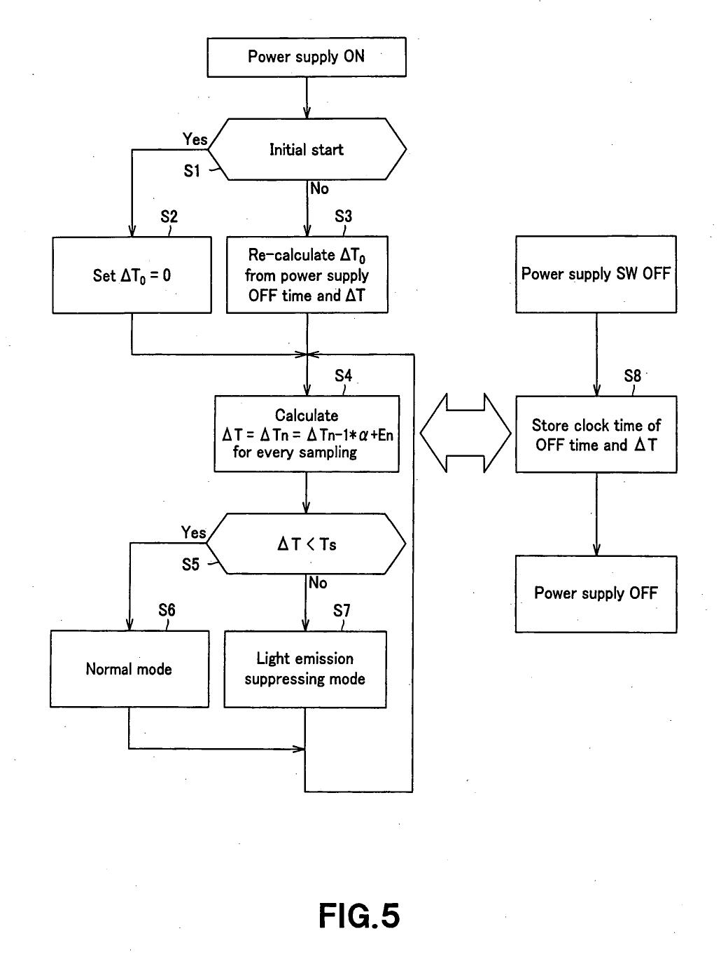

That is, as shown in the flowchart of FIG. 5, the system controller 11 judges, whether the imaging apparatus 100 is initially started when the power supply is turned on (step S1). In case of the initial start, ΔTo is set to “0” (step S2). When it is not the initial start, the ΔTo is re-calculated from a power supply off time and ΔT (step S3).

That is, after the initial power supply on, the device starts the ΔTo (temperature difference from the atmosphere) from “0”. Then, when ΔTn=ΔTn−1*α+En or the light emission of the light emission unit changes at each sampling time, the temperature approximate value at that time is calculated by formula 2 (step S4).
ΔTn=ΔTn−k*α^{k}+En formula 2

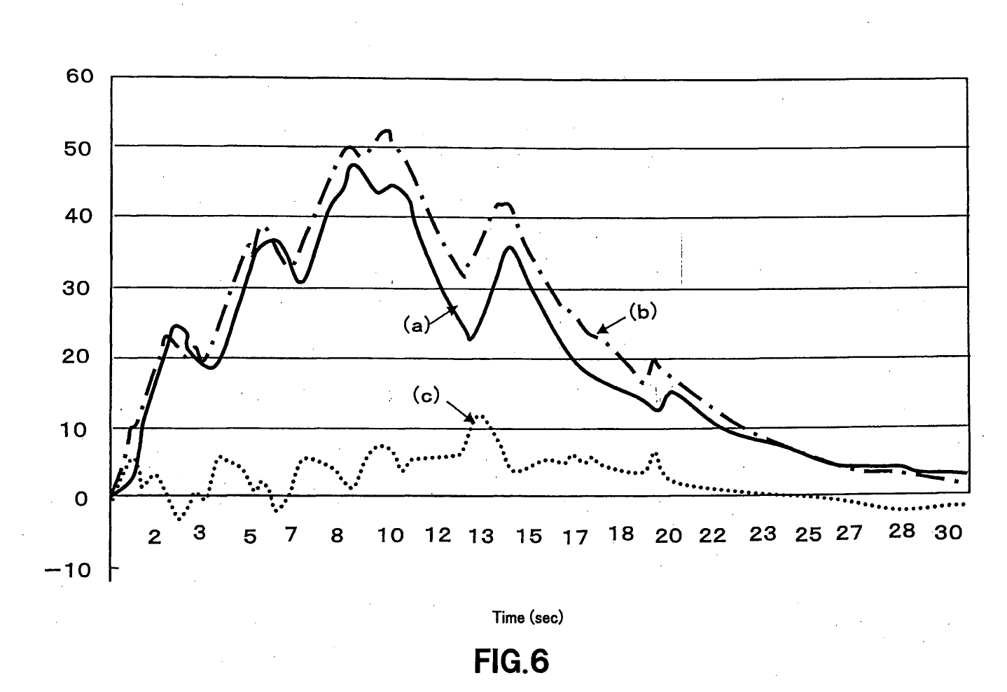

FIG. 6 shows the anticipated temperature rise curve (a) by the IIR simulation of ΔT, the actually measured temperature rise curve (b), and the error curve (c).

Then, whether ΔT is smaller than a predetermined temperature Ts is determined (step S5). When ΔT is smaller than the predetermined temperature Ts, it is operated in a normal mode (step S6). When the heat dissipation energy by the accumulated light becomes large and ΔT exceeds the predetermined temperature Ts, the device shifts the light emission to an operation of a power save mode (step S7).

In this case, when the light emission unit is the strobo, the charging time or light emission interval is forcibly extended. Thus, the heat dissipation energy is suppressed. The interval in this case is ΔT=Ts. When ΔT falls to below Ts after it has shifted to a suppression mode, the device returns to the normal mode. Further, when timing is emphasized, such as, at the time of continuous photographing the light emission interval is made constant, and a light emission power can be suppressed. Then, the system controller 11 gives a charge permission to the strobo charge controller 16, detects the charging current and limits the charging current.

Furthermore, when the power supply is off, the light emission unit radiates heat but does not emit light. Accordingly, in this imaging apparatus 100, the power supply managing unit 10 is constantly energized and stores the time of the difference from the power supply off to the power supply on (step S8). The calculation of the heat dissipation temperature by ΔTn=ΔTn−1*α is used according to the sampling period, or the calculation process of the heat dissipation simulation is collectively performed by the system controller 11 at the power supply on time from the time of difference from the power supply off to the power supply on.

In this case, the sampling period is regulated to meet the calculation capacity of the device. The device can calculate the anticipated temperature of the light emission unit even at the power supply off time with this process.

In the case of this calculating method, the temperature is not directly monitored. Accordingly, there is a possibility that the accumulation error may arise. Therefore, when the light emission does not occur for a predetermined period of time, or when the temperature difference ΔT falls to below a certain value, the calculated result is rounded to “0”. Thus, the accumulation error is cleared.

Moreover, since ΔT is the temperature difference with respect to the atmospheric temperature. The threshold value temperature Ts shifting to the suppression mode is needed to reflect the upper limit of the atmospheric temperature to be assumed. For example, the temperature is monitored at a place where the influence of the temperature rise of the device is lower than the temperature in the device. In the control that the Ts is variable according to the temperature, at a low temperature time, etc., the light emission can be repeated without receiving a limit.

Incidentally, in the above-mentioned embodiment, the case that the temperature rise of the strobo light emission unit 12 is suppressed, has been described. However, the present invention is not limited to this embodiment. For example, the suppression of the temperature rise of the light emission unit for emitting the automatic focusing (AF) in the low light-intensity or the auxiliary light for preventing the red-eyes by the light emission diode (LED), can be performed.

It should be understood by those skilled in the art that various modifications, combinations, sub-combinations and alterations may occur depending on design requirements and other factors insofar as they are within the scope of the appended claims or the equivalents thereof.

1. An imaging apparatus, comprising:
a light emission unit;
an anticipated temperature calculator that calculates an anticipated temperature of the light emission unit based on a light emission state; and
a controller for suppressing a charging current or a light emission energy of the light emission unit based on the anticipated temperature.

2. The imaging apparatus according to claim 1, wherein the controller controls to reflect information on atmospheric temperature to the anticipated temperature.

3. The imaging apparatus according to claim 2, wherein the anticipated temperature calculator updates the temperature information even in the state that a power supply of the imaging apparatus is cut.

4. The imaging apparatus according to claim 2, wherein the anticipated temperature calculator stores a time when a power supply of the imaging apparatus is turned off and calculates a temperature after heat dissipation when the power supply is turned on.

5. The imaging apparatus according to claim 2, wherein the anticipated temperature calculator discards a temperature difference to “0” when it is calculated that the temperature becomes a predetermined temperature or lower.

6. The imaging apparatus according to claim 1, wherein the anticipated temperature calculator calculates an anticipated temperature at each predetermined sampling or light emission.

7. The imaging apparatus according to claim 1, wherein the controller limits an upper limit of the changing current at a minimum light emission interval based on physical heat dissipation characteristics.

8. The imaging apparatus according to claim 1, wherein the anticipated temperature calculator calculates the anticipated temperature based on the amount of light emission.
